(19) United States
(12) Patent Application Publication
(10) Pub. No.: US 2016/0267089 A1
(43) Pub. Date: Sep. 15, 2016

(54) SYSTEM AND METHOD FOR PROVIDING GEOGRAPHICAL, CATEGORICAL, AND TEMPORAL PRESENTATION AND NAVIGATION OF CONTEXTUALLY ORGANIZED ARTISTIC, HISTORICAL, AND RELATED CONTENT

(71) Applicant: Marc Striegel, Altadena, CA (US)

(72) Inventor: Marc Striegel, Altadena, CA (US)

(21) Appl. No.: 14/642,518

(22) Filed: Mar. 9, 2015

(51) Int. Cl. G06F 17/30

(52) U.S. Cl. CPC G06F 17/30061; G06F 17/30241

(57) ABSTRACT

A system and method for providing geographical, categorical, and temporal presentation and navigation of contextually organized artistic, historical, and related content are disclosed. A particular embodiment includes: retaining, by use of a data processor, one or more libraries of artistic or historical representations and related information as a plurality of content items in a database and making the libraries of content items available to networked computer users, wherein the content items are organized in the database in groupings related to one or more geographical locations, one or more categories, and one or more chronological arrangements, the one or more geographical locations including locations depicted by the content items, the one or more chronological arrangements including times indicative of when the content items were created; providing, by use of the data processor, a computer-implemented navigation facility to enable a user to select among a plurality of browse modes including a geographical browse mode, a categorical browse mode, and a temporal browse mode; generating and presenting to the user, in response to user selection of the geographical browse mode, a corresponding map that includes markers identifying geographical locations related to the plurality of content items; generating and presenting to the user, in response to user selection of the categorical browse mode, a corresponding collection of pre-defined content item categories related to the plurality of content items; and generating and presenting to the user, in response to user selection of the temporal browse mode, a corresponding chronological arrangement that includes content item information blocks arranged in a timeline.

### TECHNICAL FIELD

This patent application relates to computer-implemented software and networked systems, according to one embodiment, and more specifically to a system and method for providing geographical, categorical, and temporal presentation and navigation of contextually organized artistic, historical, and related content.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2013-2015 Marc Striegel, All Rights Reserved.

### BACKGROUND

There is great value for learning and for growing communities by connecting those individuals having specific interests to experts in the field, as well as to each other. This principle is evidenced by traditional museums and by social networking sites for the expression of subjective tastes and opinions and by group collaboration sites, such as Wikipedia, producing significant bodies of objective knowledge. It has not, however, been applied to the general navigation, discovery, and sharing of artistic, historical, and cultural works through communities of common interests facilitated by expert curatorship.

The problem today is the lack of efficient access to all forms of artistic and historical media, including synthesized text, photographs, maps and sketches, video and audio. Historical societies and educational institutions store images and primary source information from pioneers. Libraries keep and categorize books, maps and texts, and videos. However, these content items must be purchased or searched for via the internet. Unfortunately, this does not create an efficient mode of access and sharing of these content items.

### BRIEF DESCRIPTION OF THE DRAWINGS

The various embodiments are illustrated by way of example, and not by way of limitation, in the figures of the accompanying drawings in which:

FIG. 1 illustrates an example embodiment of an artistic content management system in a network-enabled environment;

FIG. 2 illustrates an example embodiment, implemented as a web application (app), that shows the basic elements of the user interface for library selection;

FIG. 3 illustrates an example embodiment, implemented as a web app, that shows the basic elements of the user interface for browsing and accessing content items in a selected library;

FIGS. 4 through 6 illustrate the implementation of the geographical browse mode in an example embodiment;

FIGS. 7 through 9 illustrate the implementation of the categorical browse mode in an example embodiment;

FIGS. 10 and 11 illustrate the implementation of the temporal browse mode in an example embodiment;

FIG. 12 illustrates the implementation of the add or edit content item functionality in an example embodiment;

FIG. 13 illustrates the implementation of the add or edit content item geographical locations functionality in an example embodiment;

FIG. 14 illustrates the implementation of the add or edit content item categories functionality in an example embodiment;

FIG. 15 illustrates the implementation of the add or edit content item timeline or temporal functionality in an example embodiment;

FIG. 16 illustrates the implementation of additional functions to add or edit content item timelines in an example embodiment;

FIG. 17 illustrates the implementation of the social network posting functionality in an example embodiment;

FIG. 18 is a processing flow chart illustrating an example embodiment of a method as described herein;

FIG. 19 illustrates another example embodiment of a networked system in which various embodiments may operate; and

FIG. 20 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for providing geographical, categorical, and temporal presentation and navigation of contextually organized artistic, historical, and related content are disclosed. The various embodiments change the way that artistic and historical information is stored, categorized, linked, retrieved, and shared. An example embodiment described herein provides a platform to precisely link primary content source information about artistic works and about our towns, cities and villages, for example, to document how they have changed over time. Like a multi-layered cake with each stratified horizontal layer containing its own unique contextual information, artistic works and history can be logged, linked, synthesized, and viewed as a multi-layered cake with the most recent past at the top.

The various embodiments disclosed herein enable a variety of data network-connected content providers or content sources to generate item definition records that describe the items of content, the geographical location(s) associated with the content items, the content category(ies) associated with the content items, and the temporal information associated with the content items, that each content source can provide. The various embodiments also enable a variety of data network-connected client users to select, view, and navigate through a contextually categorized set of artistic, historical, and related content items in a geographical, categorical, temporal, or other contextual arrangement. The content sources can be artists, brokers, dealers, galleries, museums, vendors, distributors, content aggregators, or the like. The client users can be individual guests or organizational users, such as businesses, institutions, government, or other organizations. The content items typically include artistic works, historical items, or representations thereof in an electronic, physical, or other renderable form.

In various example embodiments described herein, the artistic content platform can receive content items and/or related content item information from the content sources via a data network. Various other network resources can also be accessed via the data network to obtain additional content item information or information related to the content items received from the content sources. From the content sources, the artistic content platform can receive their entity or company information, the content items or representations thereof, and content item information including content item geographical details, content item category details, content item temporal details, and other content item information that each content source has available. From the other network resources, the artistic content platform can receive additional content item information, such as documents, photos, sketches, maps, reviews, letters, testimonials, publications, articles, or other related information associated with a particular content item. This information can be collectively used to create content item definition records for each content item available from each of a plurality of content sources. The content item definition records can be aggregated across a plurality of content sources and retained in a network-accessible central data repository.

Once the content item definition records are created using the information as described above and the content item definition records are retained in the network-accessible central data repository, the artistic content platform can perform a variety of analysis and processing operations on the data. In a first general processing operation, the artistic content platform can organize the content items (as defined by their corresponding content item definition records) into geographical groupings based on the geographical data in the content item definition records. In a second general processing operation, the artistic content platform can organize the content items into categorical groupings based on the category data in the content item definition records. In a third general processing operation, the artistic content platform can organize the content items into temporal groupings based on the time and date data in the content item definition records. As a result of these processing operations, a user can access and view the content items in a variety of different dimensions or contexts based on a desired grouping or set of groupings. In this manner, the user can find new and useful connections between the various content items.

In the example embodiment described herein, the artistic content platform can also operate as a social networking platform to enable communication, collaboration, and sharing among authorized users. As such, any user may opt to search through content item listings and obtain customized search results and presentment of data from the searches. Users can communicate with other authorized users through the artistic content platform by posting comments for particular content items and by sharing search results or certain data sets depending on settings. Users have the capability of posting comments, reviews, or announcements related to particular content items to all users or a sub-set of users of the artistic content platform community.

In various example embodiments described in detail herein, a software application program is used to gather, process, and distribute content item information and content source information, using a computer system, a web appliance, and/or a mobile device. As described in more detail herein, the computer or computing system on which the described embodiments can be implemented can include personal computers (PCs), portable computing devices, laptops, tablet computers, personal digital assistants (PDAs), wearable computing devices, personal communication devices (e.g., cellular telephones, smartphones, or other wireless devices), network computers, set-top boxes, consumer electronic devices, or any other type of computing, data processing, communication, networking, or electronic system.

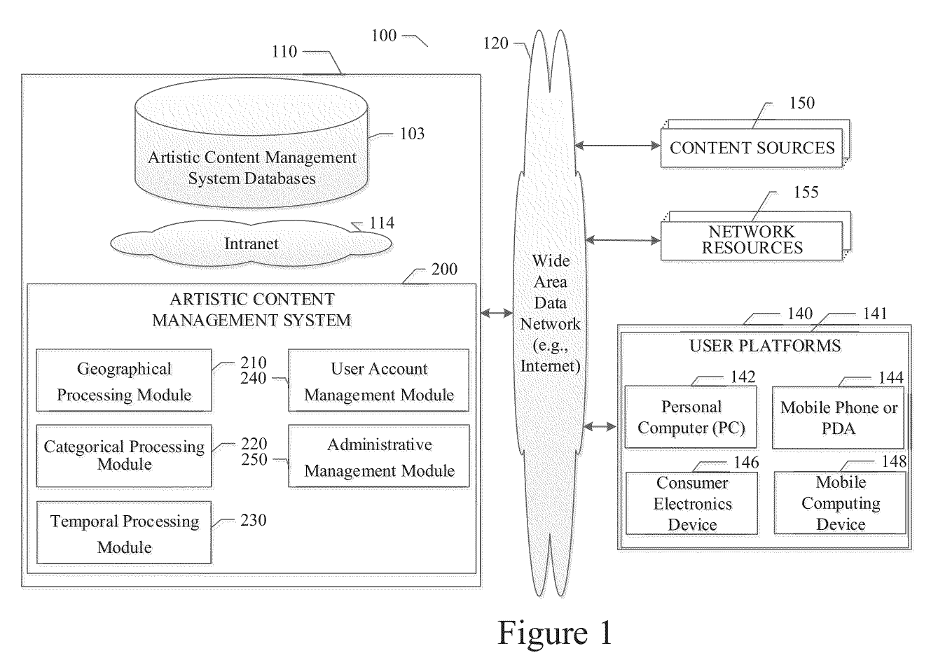

Referring now to FIG. 1, in an example embodiment, a system for artistic content management 100 in a network-enabled environment is disclosed. In various example embodiments, an application or service, typically provided by or operating on a host site (e.g., a website) 110, is provided to simplify and facilitate the downloading or hosted use of the artistic content management system 200 of an example embodiment. In a particular embodiment, the artistic content management system 200, or a portion thereof, can be downloaded from the host site 110 by a user at a user platform 140. Alternatively, the artistic content management system 200 can be hosted by the host site 110 for a networked user at a user platform 140. The details of the artistic content management system 200 of an example embodiment are provided below.

Referring again to FIG. 1, the artistic content management system 200 can be in network communication with a plurality of user platforms 140. The host site 110 and user platforms 140 may communicate and transfer data and information in the data network environment 100 shown in FIG. 1 via a wide area data network (e.g., the Internet) 120. Various components of the host site 110 can also communicate internally via a conventional intranet or local area network (LAN) 114.

In an example embodiment, the artistic content management system 200 can also be in network communication with a plurality of content sources 150 and a plurality of network resources 155. Content sources 150 can represent the network locations of clients or client computing systems being managed by content sources or client users using an embodiment described herein. For example, in a particular embodiment of the artistic content platform as shown in FIG. 1, content sources 150 can represent the network locations of clients or client computing systems of artists, brokers, dealers, galleries, museums, vendors, distributors, content aggregators, or the like. Content sources 150 can provide representations of content items and related content item information. Network resources 155 can represent the network locations of sources of information related to additional content item information, such as documents, photos, maps, reviews, sketches, letters, testimonials, publications, articles, or other related information associated with a particular content item of the artistic content management system 200 of the example embodiment.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device can act as a link between LANs, enabling messages to be sent between computing devices. Also, communication links within LANs may include optical fiber data lines, twisted wire pairs or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, BLUETOOTH, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to be moved freely and randomly and to organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The artistic content management system can be implemented using any form of network transportable digital data. The network transportable digital data can be transported in any of a group of data packet or file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JAVASCRIPT Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or instructions for the artistic content management system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JAVASCRIPT, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., TWITTER), Multimedia Message Service (MMS), instant messaging (IM), internet relay chat (IRC), mIRC, JABBER, Enhanced Messaging Service (EMS), text messaging, Smart Messaging, Over the Air (OTA) messaging, or the like, between another computing device, and the like.

As one option, the artistic content management system 200, or a portion thereof, can be downloaded to a user device 141 of user platform 140 and executed locally on a user device 141. The downloading of the artistic content management system 200 application (or a portion thereof) can be accomplished using conventional software downloading functionality. As a second option, the artistic content management system 200 can be hosted by the host site 110 and executed remotely, from the user's perspective, on host system 110. In one embodiment, the artistic content management system 200 can be implemented as a service in a service-oriented architecture (SOA) or in a Software-as-a-Service (SAAS) architecture. In any case, the functionality performed by the artistic content management system 200 is as described herein, whether the application is executed locally or remotely, relative to the user.

Referring again to FIG. 1, the host site 110 of an example embodiment is shown to include an artistic content management system database 103. The network-accessible central database 103 is used in an example embodiment for data storage of content item representations, information related to content items, content item geographical locations, content item categories, content item timelines, content sources, client users, content item definition records, configuration data, scheduling data, reporting data, and the like. Database 103 can be in data communication with the artistic content management system 200 directly or via intranet 114. It will be apparent to those of ordinary skill in the art that the database 103 can represent multiple datasets and can be used for the storage of a variety of data in support of the artistic content management system 200 of an example embodiment.

Referring again to FIG. 1, host site 110 of an example embodiment is shown to include the artistic content management system 200. Artistic content management system 200 can include a Geographical Processing Module 210, a Categorical Processing Module 220, a Temporal Processing Module 230, a User Account Management module 240, and an Administrative Management module 250. Each of these modules can be implemented as software components executing within an executable environment of artistic content management system 200 operating wholly or in part on host site 110 or user platform 140. Each of these modules of an example embodiment is described in more detail below in connection with the figures provided herein.

Referring again to FIG. 1, the artistic content management system 200 of an example embodiment is shown to include a Geographical Processing Module 210. The Geographical Processing Module 210 is responsible for receiving input from a user or a network-connectible device, the input corresponding to the geographical attributes of a content item from a content source 150, and for displaying geographically arranged content item results to a client user via any of the user interface platforms 141 described above. From the content sources 150, the Geographical Processing Module 210 can receive their content item information including item details and/or geographical details that specify the geographical attributes of a content item that each content source 150 has available. This information can be used to create content item definition records for each content item available from each of a plurality of content sources 150. The content item definition records can be aggregated across a plurality of content sources 150 and retained in a network-accessible central data repository 103.

Referring again to FIG. 1, the artistic content management system 200 of an example embodiment is shown to include a Categorical Processing Module 220. The Categorical Processing Module 220 is responsible for receiving input from a user or a network-connectible device, the input corresponding to the categorical attributes of a content item from a content source 150, and for displaying categorically arranged content item results to a client user via any of the user interface platforms 141 described above. From the content sources 150, the Categorical Processing Module 220 can receive their content item information including item details and/or categorical details that specify the categorical attributes of a content item that each content source 150 has available. This information can be used to create content item definition records for each content item available from each of a plurality of content sources 150. The content item definition records can be aggregated across a plurality of content sources 150 and retained in a network-accessible central data repository 103.

Referring again to FIG. 1, the artistic content management system 200 of an example embodiment is shown to include a Temporal Processing Module 230. The Temporal Processing Module 230 is responsible for receiving input from a user or a network-connectible device, the input corresponding to the temporal attributes of a content item from a content source 150, and for displaying temporally arranged or timeline arranged content item results to a client user via any of the user interface platforms 141 described above. From the content sources 150, the Temporal Processing Module 230 can receive their content item information including item details and/or temporal details that specify the temporal attributes of a content item that each content source 150 has available. This information can be used to create content item definition records for each content item available from each of a plurality of content sources 150. The content item definition records can be aggregated across a plurality of content sources 150 and retained in a network-accessible central data repository 103.

Referring again to FIG. 1 and as described above, a user platform 141 can include a mobile device on which a mobile application (app) can be executed. An example embodiment, implemented as a mobile device app, can be used to support a mobile device user interface for the artistic content management system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant client information from a mobile device. As described in more detail herein, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen can display a host logo and wallpaper image while opening the login screen or a live feed of processed client information.

User log-in functionality in the web application or the mobile app provides a user-friendly user interface in which the user can provide identifying information (e.g., an email address and password) associated with the user account. If the user does not have an account, the user can create an account from this user interface. The process of creating a user account in an example embodiment only requires the user to provide the identifying information (e.g., name, surname, e-mail address, and password). By completing this information, the user can create an account and get access to processed client information.

Referring again to FIG. 1, the artistic content management system 200 of an example embodiment is also shown to include a user account management module 240. The user account management module 240 can be used to create and maintain a user account on the host site 110. The user account management module 240 can also be used to configure user settings, create and maintain a user/user profile on host site 110, and otherwise manage user data and operational parameters on host site 110. In the example embodiment described herein, a user can register as an identified user in order to share content items, information, postings, documents, communications, or other content. The registered user can enter their identifying information during a log-in phase and thereafter can share content items, information, documents, communications, or other content.

Referring again to FIG. 1, the artistic content management system 200 of an example embodiment is shown to include an administrative management module 250. The administrative management module 250 can be used by an agent or administrator of the artistic content management system 200 to manage user accounts, configure system features, and to manage the artistic content management system 200. The administrative management module 250 can also be used to enforce privacy protections and content controls for users. Moreover, the administrative management module 250 can also be used to generate and/or process a variety of analytics associated with the operation of the artistic content management system 200. For example, the administrative management module 250 can generate various statistical models that represent the activity of the community of users and related content sources, client users, agents, affiliates, and the like. These analytics can be shared, licensed, or sold to others.

Although the various user interface displays provided by the example embodiments described herein are nearly infinitely varied, the descriptions of the user interface displays and sequences are provided herein to describe various features of the disclosed embodiments. These user interface displays and sequences are described herein with reference to example embodiments. It will be apparent to those of ordinary skill in the art in view of the disclosure herein that equivalent user interface displays and sequences can be implemented within the scope of the inventive subject matter disclosed and claimed herein.

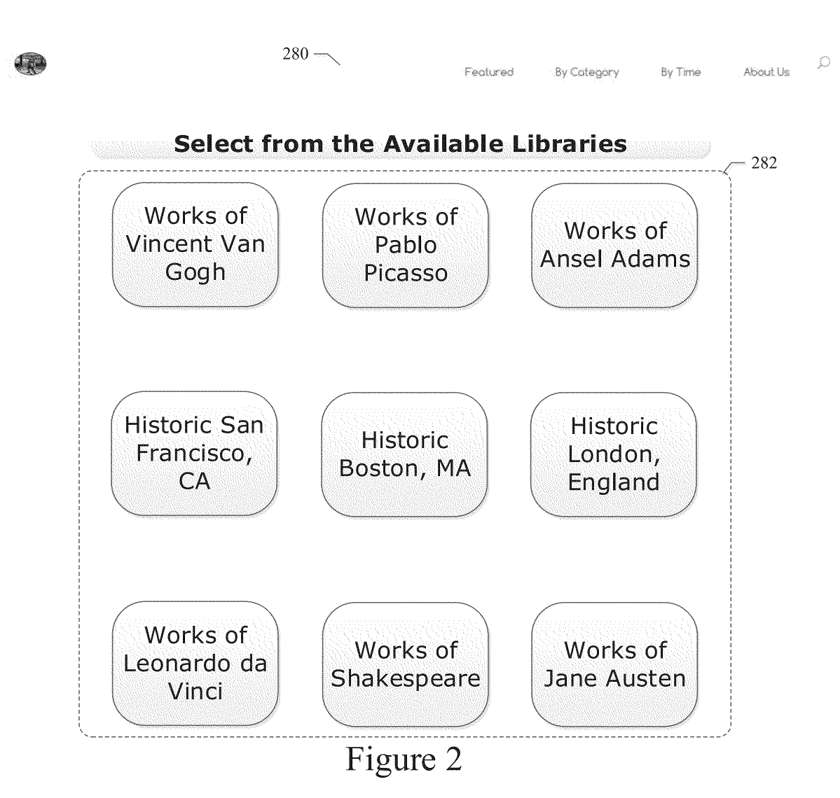

Referring now to FIG. 2, an example user interface snapshot 280, implemented as a web app, illustrates the basic elements of the user interface for library selection. It will be apparent to those of ordinary skill in the art in view of the disclosure herein that equivalent user interface displays and sequences can be implemented in a mobile app as well. As shown in FIG. 2, the sample user interface includes a set of icons or input objects 282 (enclosed in a dashed rectangle for clarity). Each of the input objects 282 enable a computing device user to select among a plurality of libraries representing collections of content items corresponding to a particular creator or subject matter. It will be apparent to those of ordinary skill in the art in view of the disclosure herein that a variety of other libraries can also be offered to a user within the scope of the embodiments described herein. In the example embodiment shown in FIG. 2, several different libraries are offered for selection in the example. These libraries can include content item collections of works by various authors, artists, inventors, and subject matter associated with several historical locations. In each of these libraries, the set of content items and content item information obtained from the content sources 150 and retained in the database 103 can be filtered and organized into contextual views in the manner described in more detail below.

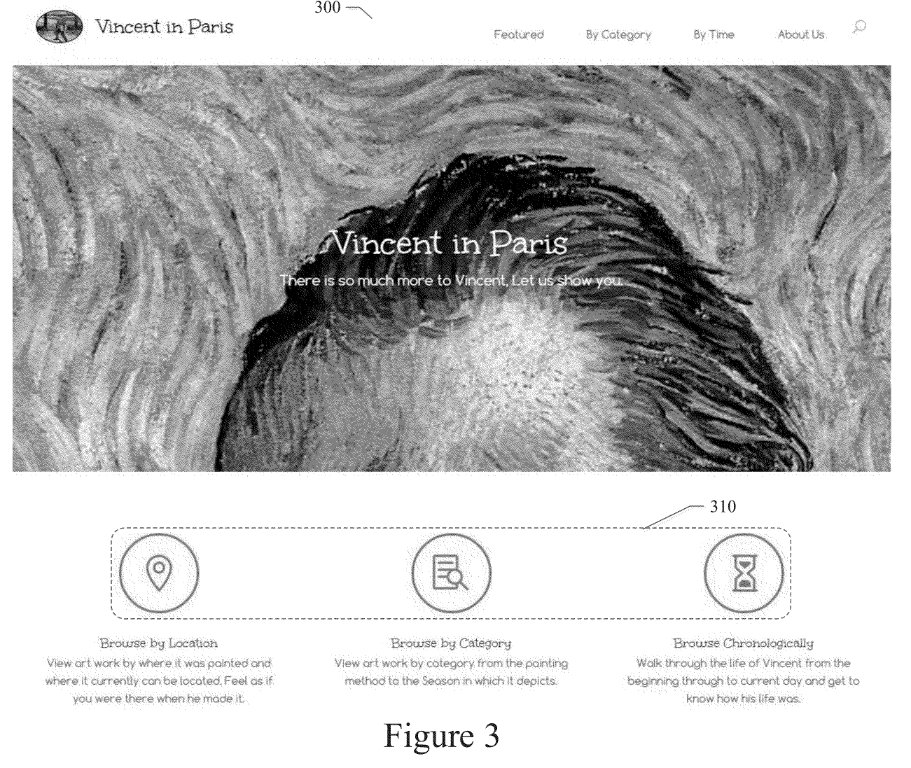

Referring now to FIG. 3, an example user interface snapshot 300, implemented as a web app, illustrates the basic elements of the user interface for browsing and accessing content items in a selected library. In the various examples shown in FIGS. 3 through 17, it is assumed for clarity of explanation that a user has selected a library from input objects 282 representing the works of Vincent van Gogh. However, it will be apparent to those of ordinary skill in the art in view of the disclosure herein that any of the libraries represented by input objects 282 can be similarly selected.

Referring again to FIG. 3, the user interface includes a set of icons or input objects 310 (enclosed in a dashed rectangle for clarity). Each of the input objects 310 enable a computing device user to select among a plurality of browse modes including a geographical browse mode (Browse by Location), a categorical browse mode (Browse by Category), and a temporal browse mode (Browse Chronologically). It will be apparent to those of ordinary skill in the art in view of the disclosure herein that a variety of other browsing modes can also be offered to a user within the scope of the embodiments described herein. In the example embodiment shown in FIG. 3, the three browse modes offered in the example, geographical browse mode, categorical browse mode, and temporal browse mode can be implemented using the Geographical Processing Module 210, the Categorical Processing Module 220, and the Temporal Processing Module 230, respectively. In each of these browse modes, the set of content items and content item information in a selected library obtained from the content sources 150 and retained in the database 103 can be filtered and organized into contextual views that correspond to a selected browse mode in a selected library.

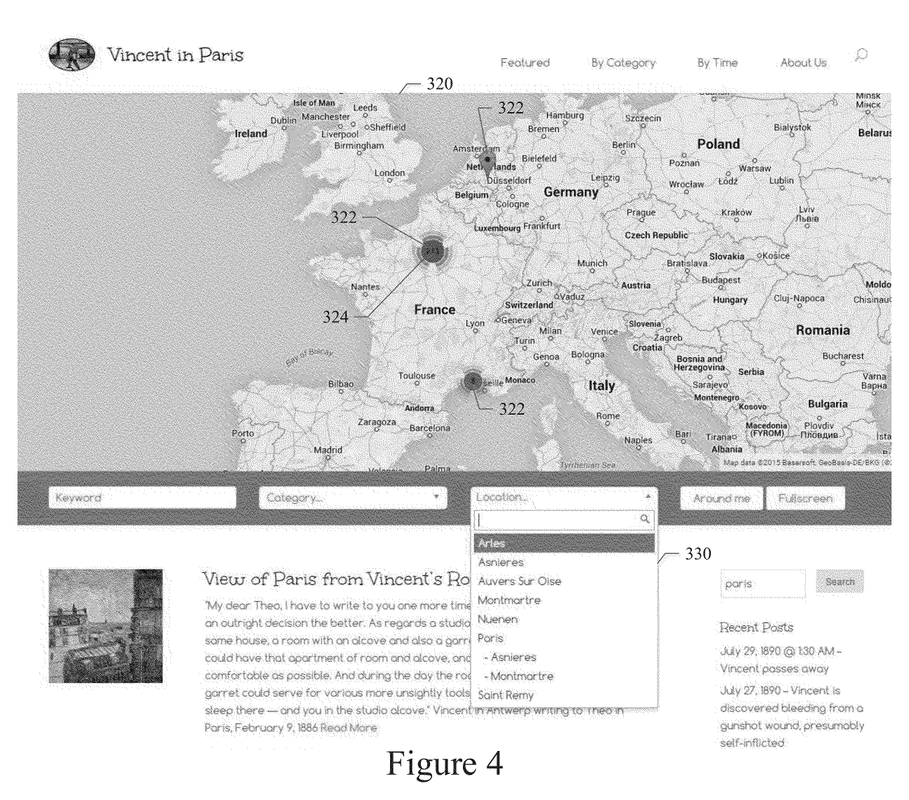

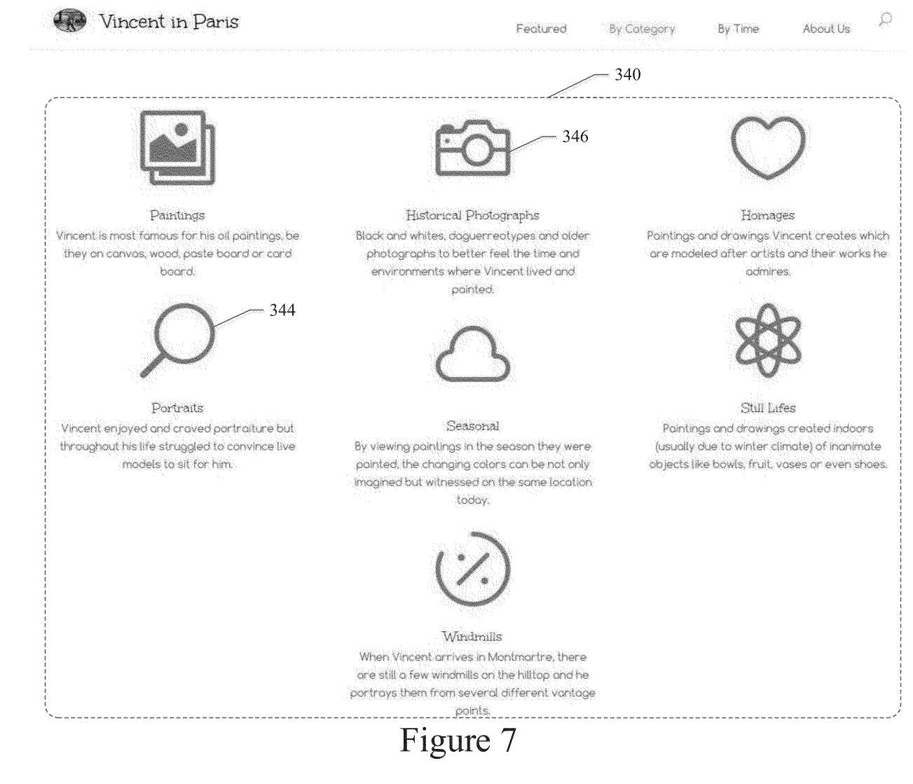

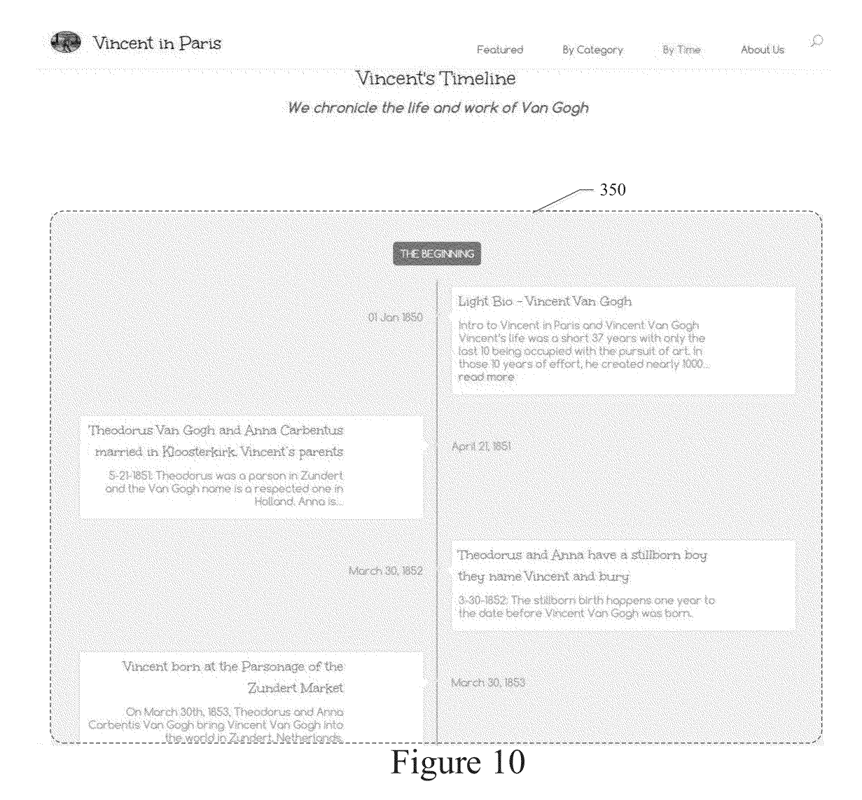

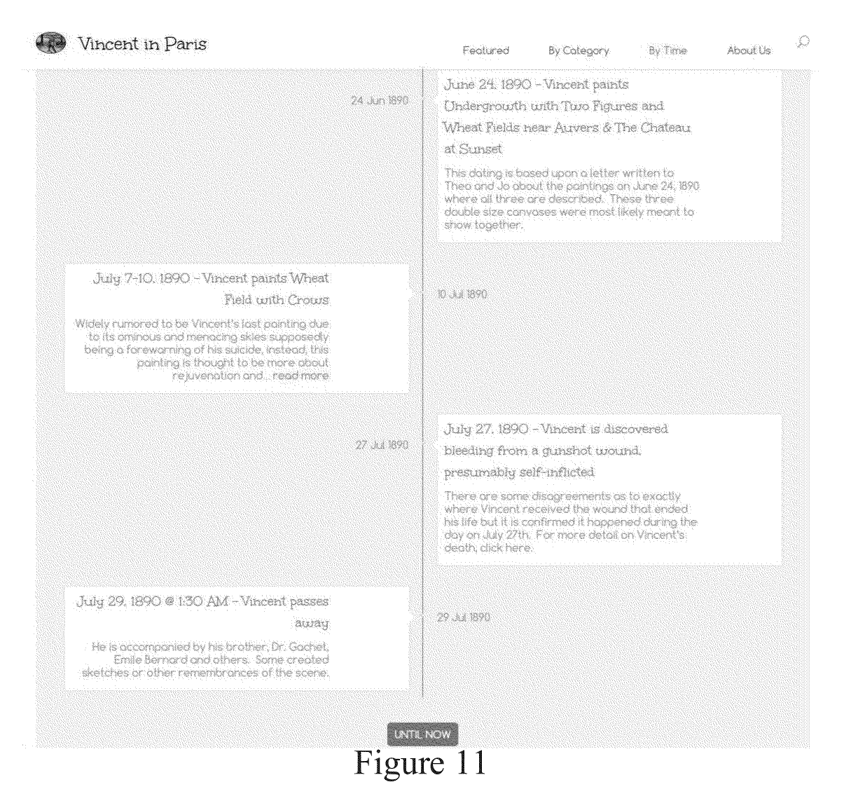

For example, if a user chooses the geographical browse mode (Browse by Location), a view of a selection of content items and related content item information can be organized into a geographically based grouping using the Geographical Processing Module 210. FIGS. 4 through 6 provided herein and described in more detail below illustrate the implementation of the geographical browse mode in an example embodiment. If a user chooses the categorical browse mode (Browse by Category), a view of a selection of content items and related content item information can be organized into a categorically based grouping using the Categorical Processing Module 220. FIGS. 7 through 9 provided herein and described in more detail below illustrate the implementation of the categorical browse mode in an example embodiment. If a user chooses the temporal browse mode (Browse Chronologically), a view of a selection of content items and related content item information can be organized into a temporally based grouping using the Temporal Processing Module 230. FIGS. 10 and 11 provided herein and described in more detail below illustrate the implementation of the temporal browse mode in an example embodiment.

FIGS. 4 through 6 illustrate the implementation of the geographical browse mode in an example embodiment. Referring now to FIG. 4, another example user interface snapshot, implemented as a web app, illustrates the user interface provided to a user when the geographical browse mode is selected. In the example embodiment, the geographical browse mode provides a geographical map 320 and location selection region 330. In an example embodiment, the geographical map 320 acts as a filter that allows the user to see the locations associated with content items or other content information relevant to their geographical location (geo-location) or a selected geo-location. The map of a particular default location can be declared by the user when setting up their account. The default location can be modified using an application tool. Alternatively, the default geo-location for the user can be obtained based on a selected set of content items and the geographical locations associated therewith. Additionally, the default geo-location for the user can be obtained through the user's browser or automatically obtained using other well-known techniques. The user can also select from a plurality of geo-location options provided in location selection region 330. The location options provided in location selection region 330 can correspond to the pre-defined geo-locations to which clusters of content items can be related. For example, a geo-location where a content item (e.g., an artistic work) was created can be offered as a location option. Additionally, locations where an artist was born, worked, lived, or died can be offered. Locations depicted in content items (e.g., artistic works) can also be offered as location options. It will be apparent to those of ordinary skill in the art in view of the disclosure herein that a variety of other geo-locations associated with particular content items can be similarly offered as selections in the location selection region 330. In an example embodiment, the user can scroll the map 320 and zoom in and out using standard map navigation tools. The map 320 shows detailed information about the selected location. The map 320 also provides markers or icons 322 on the map that indicate the sites or geo-locations associated with particular content items. A numeric value within each icon 322 indicates a number of content items associated with the particular site. The size, color, or type of the icon can also be used to indicate a number of content items or a type of content items associated with the particular site. When the user selects (e.g., clicks on) an icon 322 on the map 320, the user is shown a detail of the selected site and markers corresponding to the content items associated with the selected site. In many cases, the map 320 is automatically zoomed in to detail the selected site. The user can browse the map 320 to find and select markers or icons 322 associated with particular content items attached to specific points or geo-locations on the map 320. The user can zoom the map 320 in or out using the standard map navigation tools. The map 320 serves as a visual filter that allows the user to explore and find content items by geo-location.

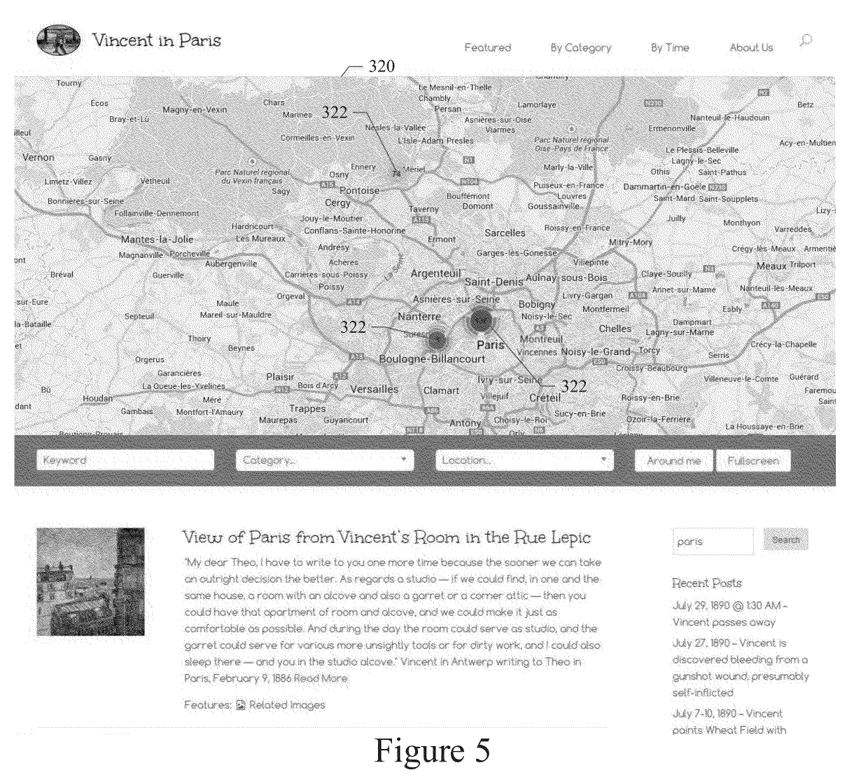

Referring now to FIG. 5, another example user interface snapshot, implemented as a web app, illustrates the user interface provided to a user when the geographical browse mode is active (e.g., previously selected by the user) and the user has selected a particular marker or icon 324 shown in FIG. 4. In this sample case, the user has selected a location on the map near Paris, France where a cluster of content items, in this example, have a geographical connection. As a result of this selection, the user interface shown in FIG. 5 is generated by an example embodiment and displayed to the user. The map 320 has been automatically zoomed in to reveal more detailed geo-locations associated with particular content items. The zoomed-in map 320 shown in FIG. 5 also provides markers or icons 322 on the map 320 that indicate the sites or geo-locations associated with particular content items. The user can continue this process of selecting desired geo-locations associated with particular content items.

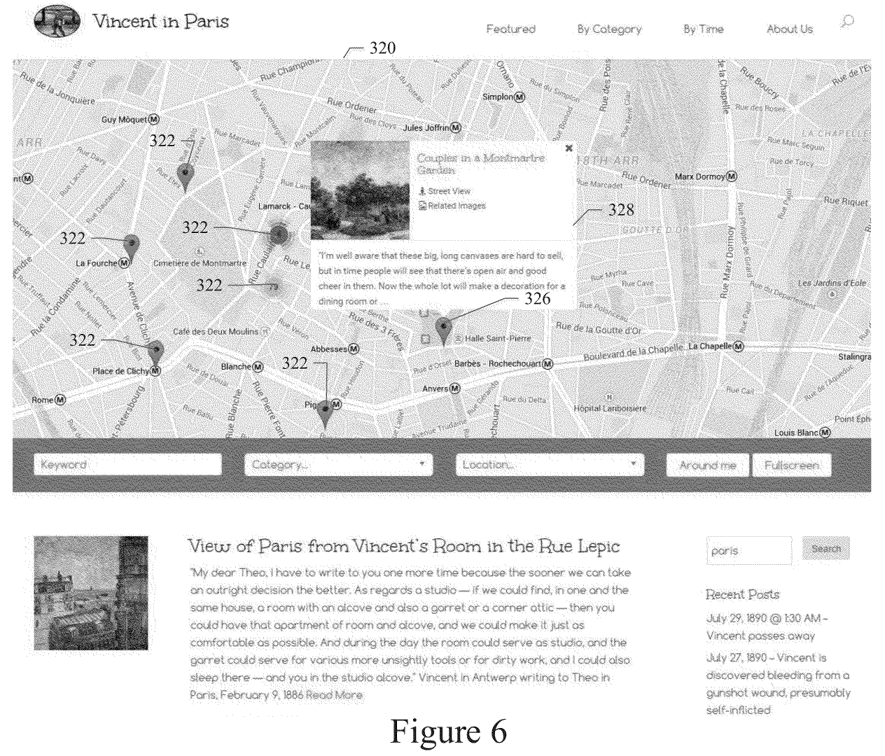

Referring now to FIG. 6, another example user interface snapshot, implemented as a web app, illustrates the user interface provided to a user when the geographical browse mode is active (e.g., previously selected by the user) and the user has selected a particular marker or icon 326 shown in FIG. 6. In this sample case, the user has selected a particular geo-location on the map near Paris, France where a particular content item has a geographical connection. As a result of this selection, the content item detail information block 328 as shown in FIG. 6 is generated by an example embodiment and displayed to the user. The content item detail information block 328 in an example embodiment can display a variety of information associated with the content item connected to the selected geo-location. For example, the content item detail information block 328 can include a visual representation (e.g., an image, animation, video, or the like) of the content item, a block of text providing detail information on the content item, an icon or input object that can be selected to hear an audio clip with detail information on the content item, and a variety of other detail information. Additionally, the content item detail information block 328 can include links to related content items or related content item information. In the example shown in FIG. 6, the content item detail information block 328 includes a textual description of the related content item connected to the selected geo-location, a link to a street view of the selected location, and a link to related images and information associated with the content item connected to the selected geo-location. It will be apparent to those of ordinary skill in the art in view of the disclosure herein that a variety of additional information and links can be provided in the content item detail information block 328. A portion of the user interface display area below the map 320 as shown in FIG. 6 can also be used to display information related to the particular content item or related items.

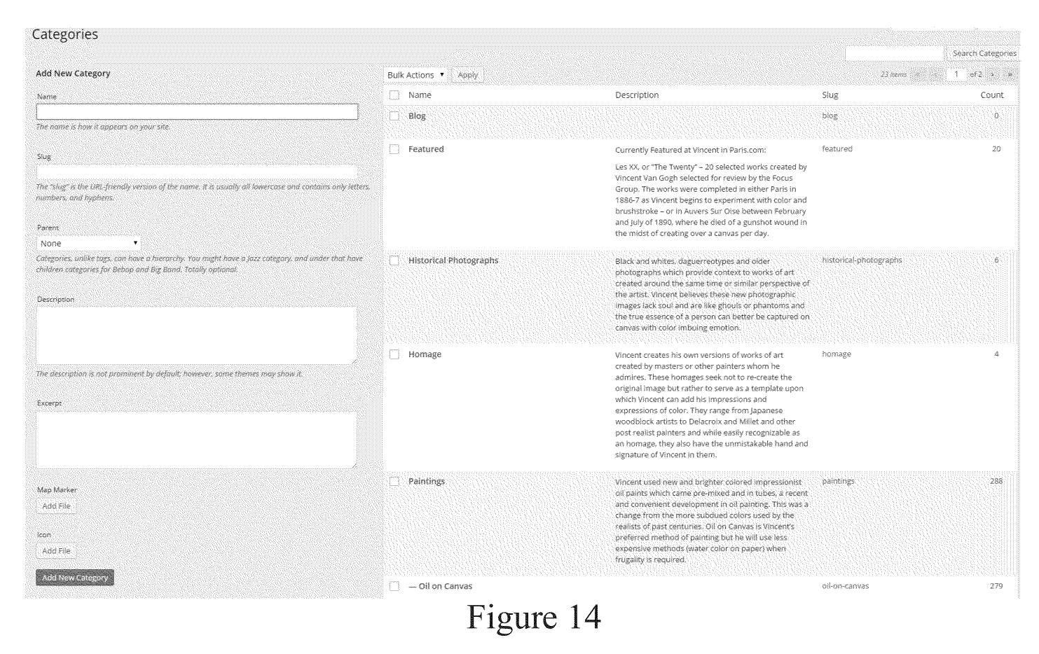

FIGS. 7 through 9 illustrate the implementation of the categorical browse mode in an example embodiment. Referring now to FIG. 7, another example user interface snapshot, implemented as a web app, illustrates the user interface provided to a user when the categorical browse mode is selected. As shown, the user interface includes a set or collection of icons or input objects 340 (enclosed in a dashed rectangle for clarity). Each of the input objects 340 enable a computing device user to select among a collection or plurality of pre-defined content item categories. In the example embodiment, the categorical browse mode provides input objects 340 representing a collection of pre-defined content item categories, including paintings, historical photographs, homages, portraits, seasonal works, still lifes, and windmills. It will be apparent to those of ordinary skill in the art in view of the disclosure herein that a variety of other content item categories associated with particular content items can be similarly offered as selections with corresponding input objects 340. In an example embodiment, each pre-defined content item category acts as a filter that allows the user to see a particular contextual collection of content items or other content item information relevant to the selected content item category. As described in more detail below in connection with FIG. 14, the content item categories associated with a particular set of content items can be pre-defined by an administrator of the host site 110. For example, the pre-defined content item categories can include categories related to the type of content item (e.g., painting, artistic work, historical artifact, etc.), the style in which the content item was created (e.g., impressionist, realist, cubist, etc.), the type of image depicted in the content item (e.g., still life, portrait, landscape, etc.), the presence of a particular object in the content item, (e.g., windmills, flowers, birds, etc.), a particular theme or genre associated with the content item (e.g., homage, seasonal, architectural, etc.), and the like. The content item categories can be as varied as the collection of content items themselves. The content item categories can also include collections of other pre-defined content item categories in a hierarchy. Each category can have a corresponding input object 340 by selection of which the category can be activated.

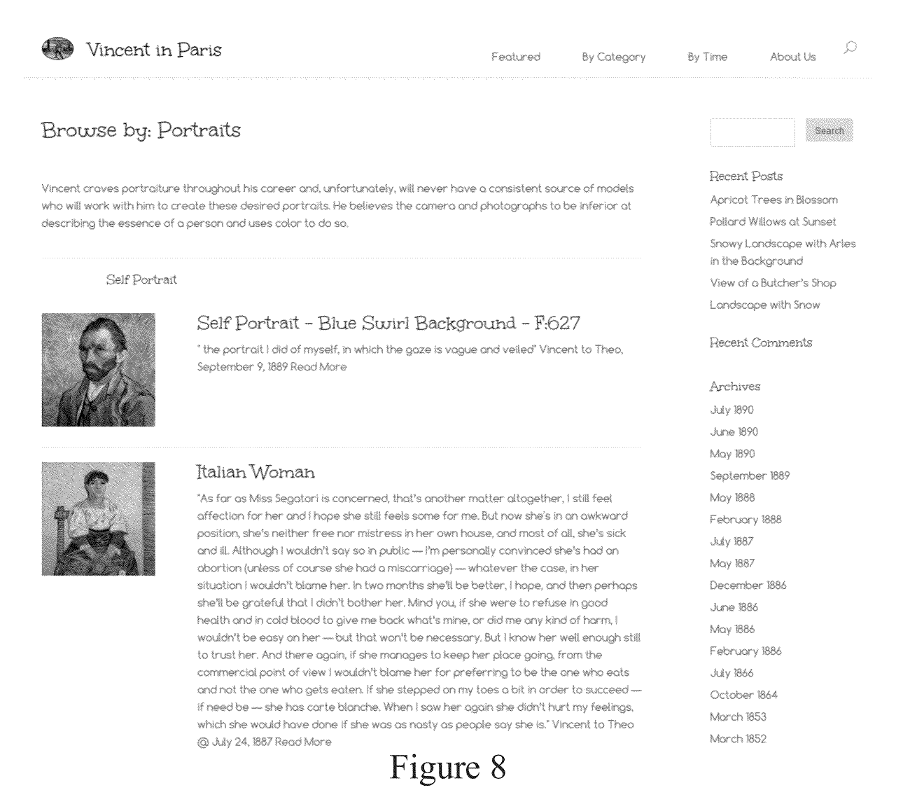

Referring now to FIG. 8, another example user interface snapshot, implemented as a web app, illustrates the user interface provided to a user when the categorical browse mode is active (e.g., previously selected by the user) and the user has selected a particular icon 344 shown in FIG. 7. In this sample case, the user has selected the portrait category where a cluster of content items having a connection to a portrait category can be browsed. As a result of this selection, the user interface shown in FIG. 8 is generated by an example embodiment and displayed to the user. As shown in FIG. 8, the cluster of content items having a connection to a portrait category are displayed to the user as a list of content item details. Each content item detail in the list can include a visual representation (e.g., an image, animation, video, or the like) of the content item, a block of text providing detail information on the content item, an icon or input object that can be selected to hear an audio clip with detail information on the content item, and a variety of other detail information. Additionally, the content item detail information can include links to related content items or related content item information. In the example shown in FIG. 8, the content item detail information can include a textual description of the related content item connected to the selected category, a link to other views of the content item, and a link to related images and information associated with the content item connected to the selected category. It will be apparent to those of ordinary skill in the art in view of the disclosure herein that a variety of additional information and links can be provided in the content item detail information for each content item in the list of content items connected to the selected category. The list of content item details can be scrolled to enable the presentation of a plurality of content items connected to the selected category.

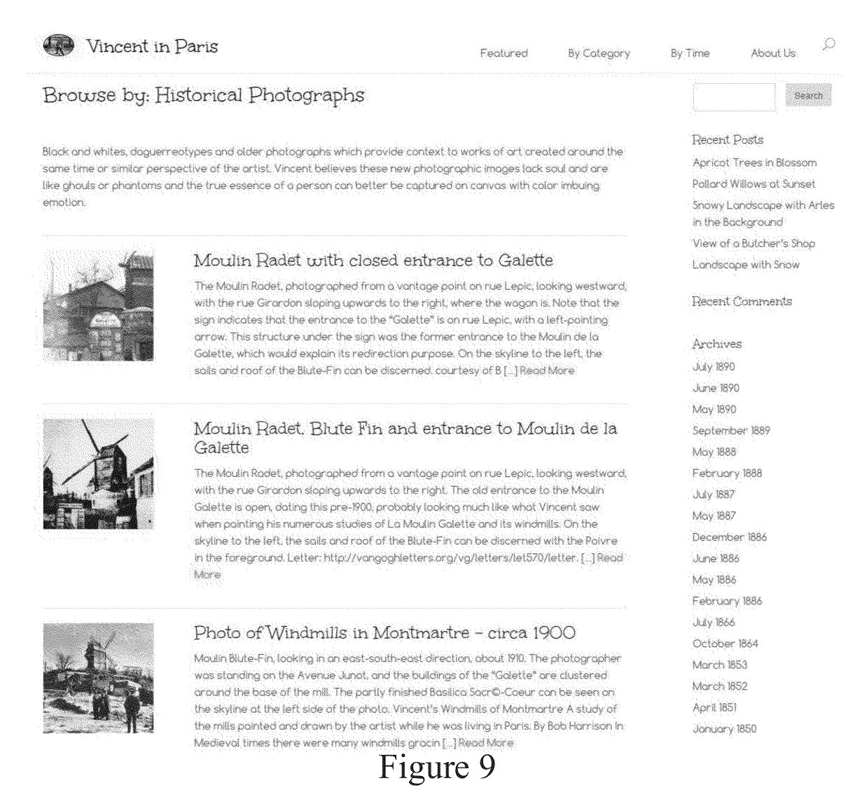

Referring now to FIG. 9, another example user interface snapshot, implemented as a web app, illustrates the user interface provided to a user when the categorical browse mode is active (e.g., previously selected by the user) and the user has selected a particular icon 346 shown in FIG. 7. In this sample case, the user has selected the historical photograph category where a cluster of content items having a connection to a historical photograph category can be browsed. As a result of this selection, the user interface shown in FIG. 9 is generated by an example embodiment and displayed to the user. As shown in FIG. 9, the cluster of content items having a connection to a historical photograph category are displayed to the user as a list of content item details. In the example of FIG. 9, the list includes content items and content item information that are connected by or include a historical photograph. The list of content item details can be scrolled to enable the presentation of a plurality of content items connected to the selected category.

FIGS. 10 and 11 illustrate the implementation of the temporal browse mode in an example embodiment. Referring now to FIG. 10, another example user interface snapshot, implemented as a web app, illustrates the user interface provided to a user when the temporal browse mode is selected. As shown, the user interface includes a timeline of content item information blocks 350 (enclosed in a dashed rectangle for clarity). In the example embodiment, the temporal browse mode provides content item information blocks 350 representing a collection of content items organized in a chronological arrangement or timeline. Each content item information block represents an event or a notable time period associated with a content item in a selected library. For example, the timeline may start at the top of the user interface view with the birth of the creator of the works for which content items are retained in the selected library. In other cases, as shown in FIG. 10 for the library related to the works of Vincent van Gogh, the timeline may start in the year 1850 when the particular artist began the creation of the bulk of his work. For a library related to the content items associated with another artist, author, or inventor, the timeline may begin with the earliest works created by the artist, author, or inventor and then progress chronologically as the artist, author, or inventor develops his/her works over time. For a library related to the content items associated with a historical location, the timeline may begin with the earliest photograph or image of the particular location and then progress chronologically as the historical location grows or develops over time. It will be apparent to those of ordinary skill in the art in view of the disclosure herein that a variety of other chronological arrangements of content item information blocks associated with particular content items can be similarly generated and presented to a user.

FIG. 11 illustrates another example user interface snapshot implemented as a web app, showing another view of the timeline of content item information blocks 350. In the example embodiment, the temporal browse mode provides content item information blocks representing a collection of content items arranged in a chronological view or timeline. Each content item information block in the timeline can include a visual representation (e.g., an image, animation, video, or the like) of a content item, a block of text providing detail information about the particular date/time or information related to a particular content item, an icon or input object that can be selected to hear an audio clip with detail information about the particular date/time or information related to the particular content item, and a variety of other detail information. Additionally, the content item information block in the timeline can include links to related content items or related content item information. In the examples shown in FIGS. 10 and 11, the content item information blocks in the timeline can include a textual description of the related content item connected to the particular date/time, a link to other views of the content item, and a link to related images and information associated with the content item connected to the particular date/time. It will be apparent to those of ordinary skill in the art in view of the disclosure herein that a variety of additional information and links can be provided in the content item information blocks in the timeline. The timeline of content item information blocks can be scrolled to enable the presentation of a plurality of content item information blocks connected to the particular timeline.

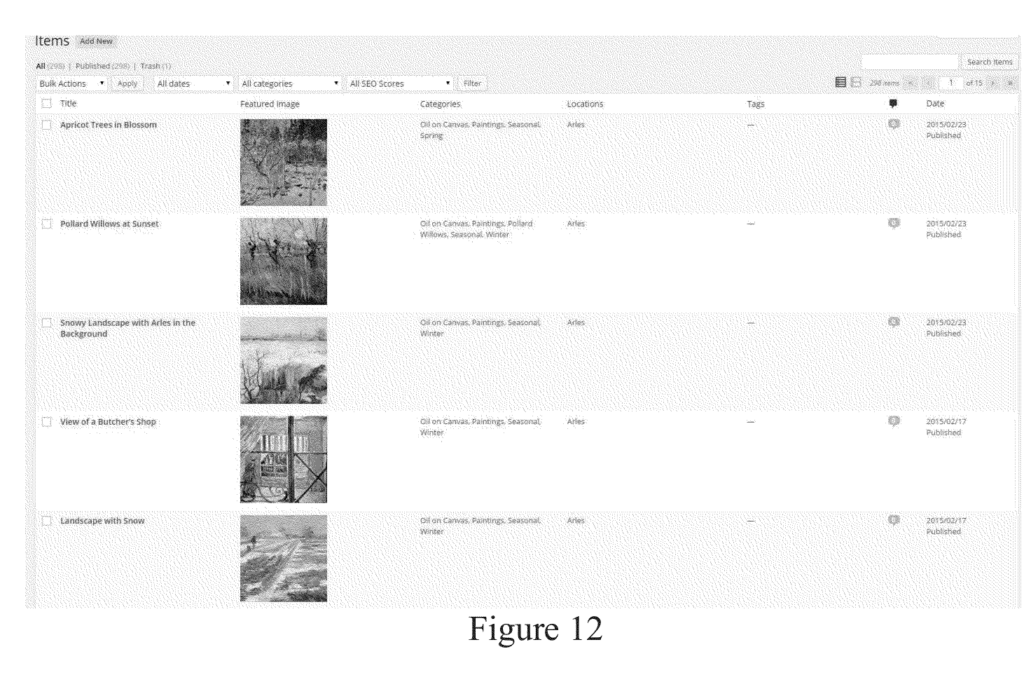

FIGS. 12 through 17 illustrate the implementation of the administrative functions to support the functionality in an example embodiment. The administrative functions in an example embodiment include the functions for: 1) managing the procurement and retention of content items and the creation and editing of content item meta data and other information related to the content items; 2) managing the geo-location data, maps, and geo-location views associated with the content items; 3) managing the creation and editing of content item categories and other information related to the content item categories; and 4) managing the creation and editing of content item timelines and other information related to the temporal aspects of the content items. Each of these administrative functions are described below in connection with the figures provided herewith. It will be apparent to those of ordinary skill in the art in view of the disclosure herein that a variety of additional administrative functions can be provided to support the system and method for providing geographical, categorical, and temporal presentation and navigation of contextually organized artistic, historical, and related content as described herein.

FIG. 12 illustrates the implementation of the add or edit content item functionality in an example embodiment. In general, the add or edit content item functionality provides system tools to manage the procurement and retention of content items and to create and edit content item meta data and other information related to the content items. In the example embodiment, the user interface provided by the artistic content management system 200 provides an “Add New” input object with which an administrative user can obtain a new content item, or a representation thereof, from a content source 150 via network 120. The administrative user can also use provided tools to obtain additional or ancillary content item information from the content sources 150 or other network resources 155. The new content item and its related data can be retained in the database 103. Using other administrative tools provided as part of the add or edit content item functionality as shown in FIG. 12, the administrative user can define or edit a title of a content item, provide an image or audio clip of the content item, specify one or more categories with which the content item can be associated, specify one or more geo-locations with which the content item can be associated, specify one or more tags with which the content item can be associated, and add comments related to the content item. The user interface, as shown in FIG. 12, also enables the administrative user to view lists of filtered and sorted content items and to search through the set of content items stored in database 103.

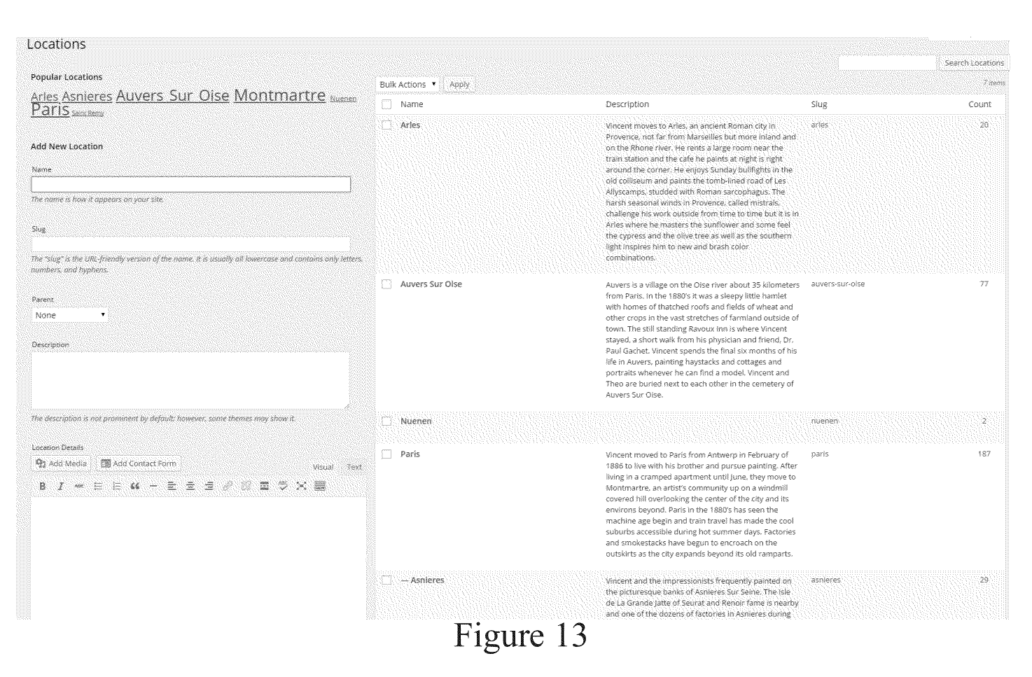

FIG. 13 illustrates the implementation of the add or edit content item geographical locations functionality in an example embodiment. This administrative function enables an administrative user to define or edit geo-locations to which content items can be related. In the example embodiment, the user interface provided by the artistic content management system 200 provides an “Add New Location” input region with which an administrative user can specify or edit the details of a particular geographical location. The administrative user can use provided tools to specify or edit the name, link, hierarchy, and description of a particular pre-defined geographical location. In this manner, groups of content items can be associated with one or more geographical locations and each pre-defined geo-location can have an associated name, link, hierarchy, and description. The new or revised pre-defined geo-location and its related data can be retained in the database 103. The user interface, as shown in FIG. 13, also enables the administrative user to view lists of filtered and sorted pre-defined geo-locations and to search through the set of pre-defined geo-locations stored in database 103.

FIG. 14 illustrates the implementation of the add or edit content item categories functionality in an example embodiment. This administrative function enables an administrative user to define or edit categories to which content items can be related. In the example embodiment, the user interface provided by the artistic content management system 200 provides an “Add New Category” input region with which an administrative user can specify or edit the details of a particular content item category. The administrative user can use provided tools to specify or edit the name, link, hierarchy, and description of a particular pre-defined content item category. In this manner, groups of content items can be associated with one or more categories and each pre-defined category can have an associated name, link, hierarchy, and description. The new or revised pre-defined content item category and its related data can be retained in the database 103. The user interface, as shown in FIG. 14, also enables the administrative user to view lists of filtered and sorted pre-defined content item categories and to search through the set of pre-defined categories stored in database 103.

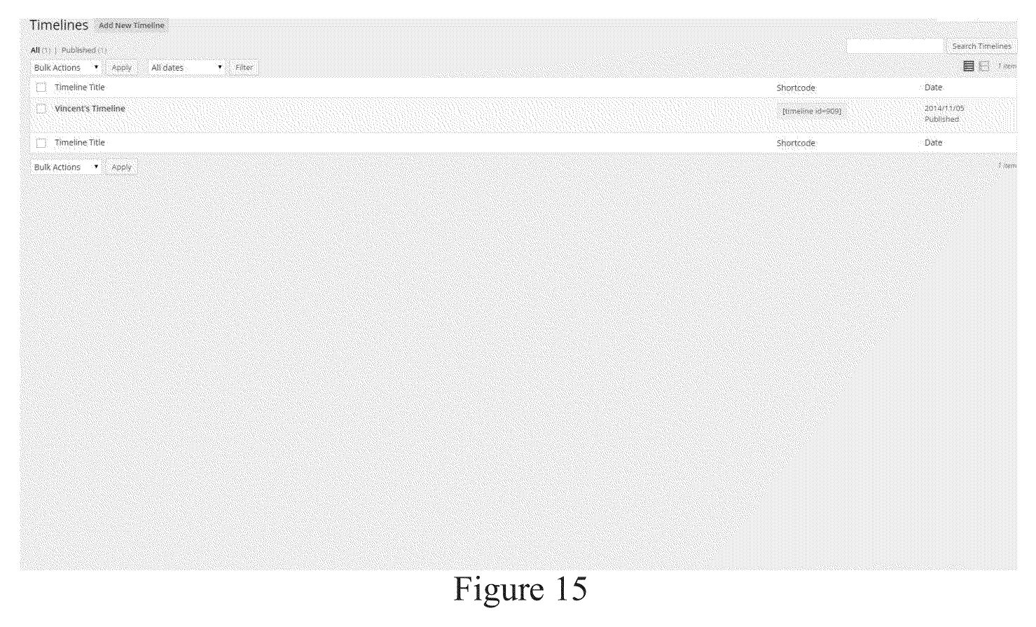

FIG. 15 illustrates the implementation of the add or edit content item timeline or temporal functionality in an example embodiment. This administrative function enables an administrative user to define or edit content item timelines to which content items can be related. In the example embodiment, the user interface provided by the artistic content management system 200 provides an “Add New Timeline” input region with which an administrative user can specify or edit the details of a particular content item timeline. The administrative user can use provided tools to specify or edit the name of a particular pre-defined content item timeline. In this manner, groups of content items can be associated with one or more timelines and each pre-defined timeline can have an associated name. The dates/times associated with each content item can be used to position information blocks associated with the content items at the appropriate date/time locations on the timeline. The new or revised pre-defined content item timeline and its related data can be retained in the database 103. The user interface, as shown in FIG. 15, also enables the administrative user to view lists of filtered and sorted pre-defined content item timelines and to search through the set of pre-defined timelines stored in database 103.

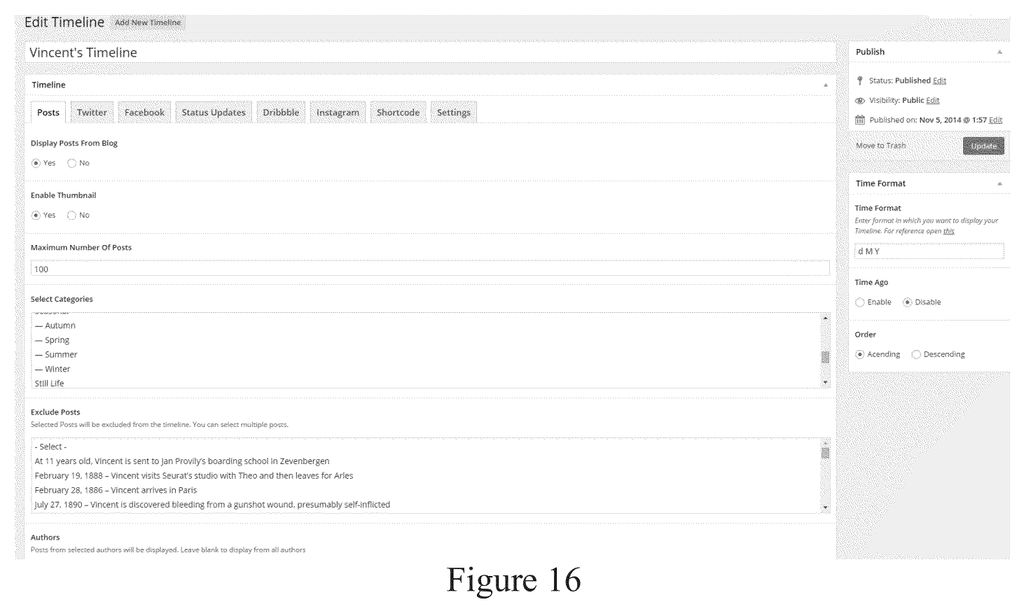

FIG. 16 illustrates the implementation of additional functions to add or edit content item timelines in an example embodiment. The user interface, as shown in FIG. 16, enables the administrative user to associate selected categories and posting sources with a particular pre-defined timeline. Category selection enables the items shown on the particular timeline to be time-sorted and filtered based on the selected category(ies). Posting source selection enables the items shown on the particular timeline to be time-sorted and filtered based on the selected posting source(s) and the postings therefrom. In a particular example embodiment, the supported posting sources include Twitter™, Facebook™, Dribbble™, and Instagram™. It will be apparent to those of ordinary skill in the art in view of the disclosure herein that a variety of additional posting sources can be supported by the system and method disclosed herein.

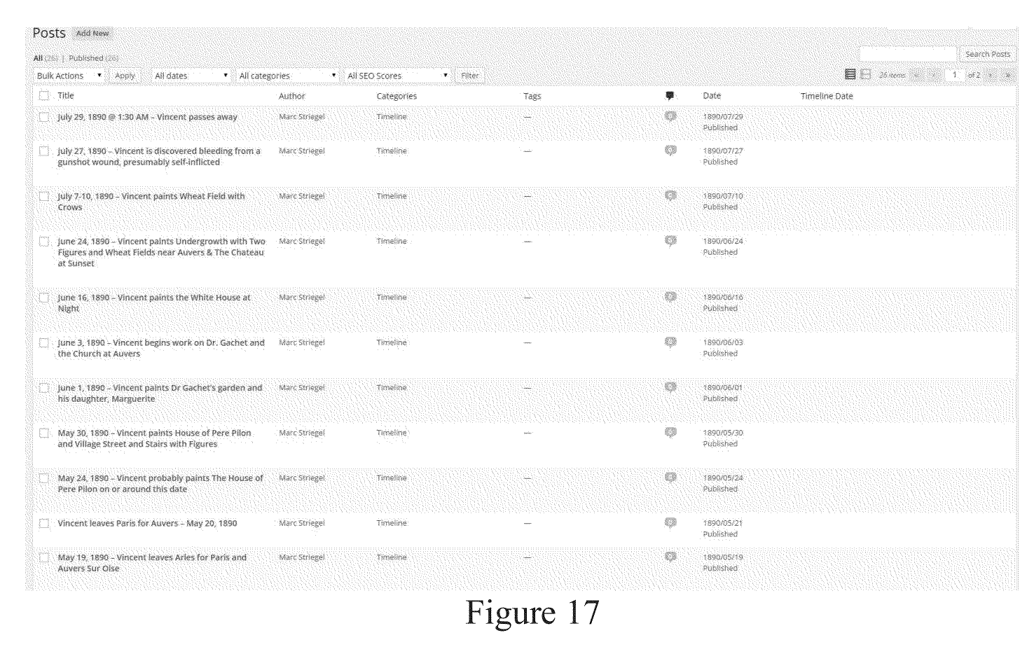

FIG. 17 illustrates the implementation of the social network posting functionality in an example embodiment. This administrative function enables an administrative user to manage postings related to particular content items. In the example embodiment, the user interface provided by the artistic content management system 200 provides an “Add New” input object with which an administrative user can create or edit the details of a particular posting. The administrative user can use provided tools to view the title, author, category, tag, and date information for a particular posting. In this manner, postings from a variety of sources can be related to content items and each posting can have an associated title, author, category, tag, and date information. The postings and their related data can be retained in the database 103 or retained by the particular posting site. The user interface, as shown in FIG. 17, also enables the administrative user to view lists of filtered and sorted postings and to search through the set postings stored in database 103. As a result, the various embodiments described herein provide a social networking community focused on libraries of artistic and historical content items and a means for networked users to share their experiences with these content items.

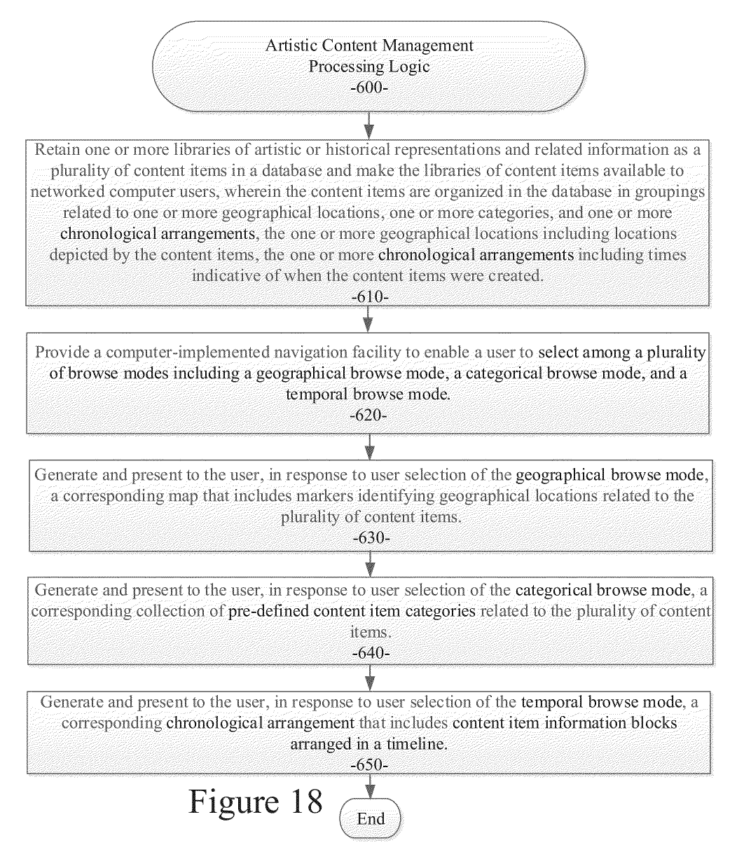

Referring now to FIG. 18, a processing flow diagram illustrates an example embodiment of an artistic content management system 200 as described herein. The method 600 of an example embodiment includes: retaining, by use of a data processor, one or more libraries of artistic or historical representations and related information as a plurality of content items in a database and making the libraries of content items available to networked computer users, wherein the content items are organized in the database in groupings related to one or more geographical locations, one or more categories, and one or more chronological arrangements, the one or more geographical locations including locations depicted by the content items, the one or more chronological arrangements including times indicative of when the content items were created (processing block 610); providing, by use of the data processor, a computer-implemented navigation facility to enable a user to select among a plurality of browse modes including a geographical browse mode, a categorical browse mode, and a temporal browse mode (processing block 620); generating and presenting to the user, in response to user selection of the geographical browse mode, a corresponding map that includes markers identifying geographical locations related to the plurality of content items (processing block 630); generating and presenting to the user, in response to user selection of the categorical browse mode, a corresponding collection of pre-defined content item categories related to the plurality of content items (processing block 640); and generating and presenting to the user, in response to user selection of the temporal browse mode, a corresponding chronological arrangement that includes content item information blocks arranged in a timeline (processing block 650).

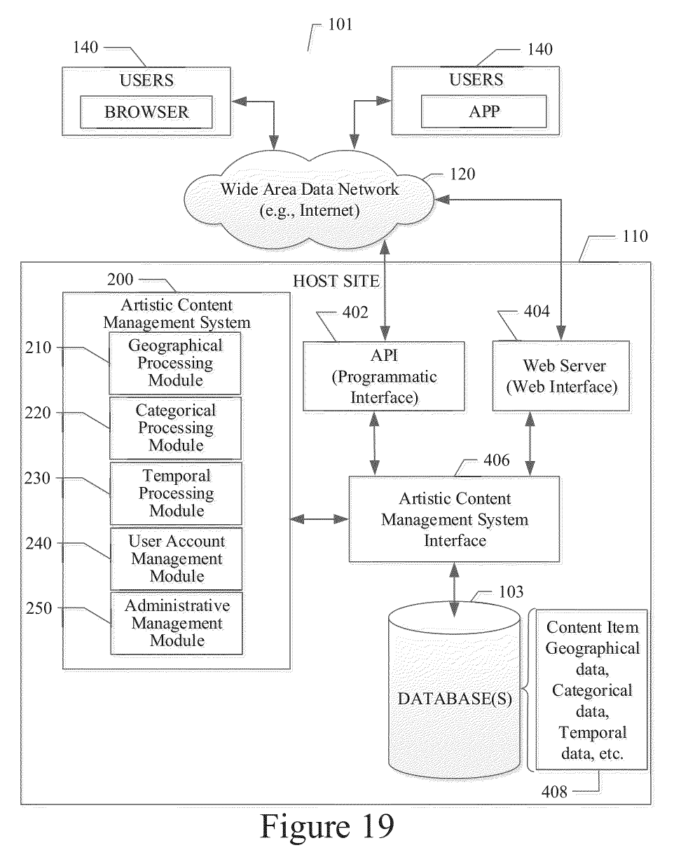

Referring now to FIG. 19, another example embodiment 101 of a networked system in which various embodiments may operate is illustrated. In the embodiment illustrated, the host site 110 is shown to include the artistic content management system 200. The artistic content management system 200 is shown to include the functional components 210 through 250, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the artistic content management system 200 either directly or via an interface 406. The artistic content management system 200 may be configured to access a data storage device 103 and data 408 therein either directly or via the interface 406.

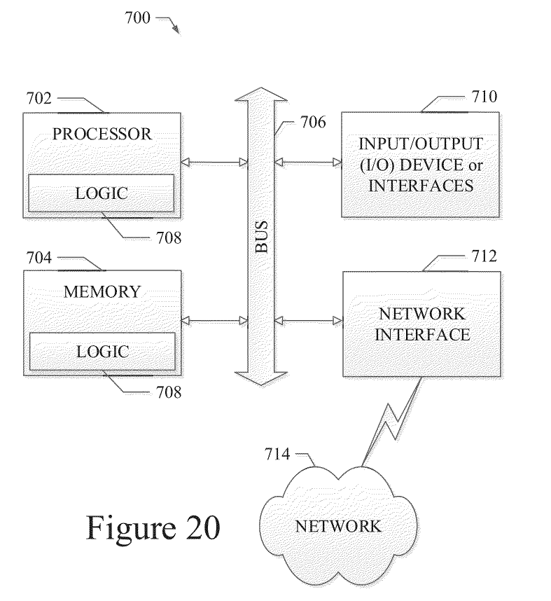

FIG. 20 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network muter, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, BLUETOOTH, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method for geographical, categorical, and temporal presentation and navigation of contextually organized artistic, historical, and related content, the method comprising:
retaining, by use of a data processor, one or more libraries of artistic or historical representations and related information as a plurality of content items in a database and making the libraries of content items available to networked computer users, wherein the content items are organized in the database in groupings related to one or more geographical locations, one or more categories, and one or more chronological arrangements, the one or more geographical locations including locations depicted by the content items, the one or more chronological arrangements including times indicative of when the content items were created;
providing, by use of the data processor, a computer-implemented navigation facility to enable a user to select among a plurality of browse modes including a geographical browse mode, a categorical browse mode, and a temporal browse mode;
generating and presenting to the user, in response to user selection of the geographical browse mode, a corresponding map that includes markers identifying geographical locations related to the plurality of content items;
generating and presenting to the user, in response to user selection of the categorical browse mode, a corresponding collection of pre-defined content item categories related to the plurality of content items; and
generating and presenting to the user, in response to user selection of the temporal browse mode, a corresponding chronological arrangement that includes content item information blocks arranged in a timeline.

2. The method of claim 1 wherein the plurality of content items are obtained from a plurality of content sources via a data network.

3. The method of claim 1 further including enabling a user to select among a plurality of content item libraries.

4. The method of claim 1 wherein the one or more geographical locations including locations where the content items were created or locations where the creator of the content items resided.

5. The method of claim 1 wherein the map markers further including an indication of a number of content items associated with a particular geographical location.

6. The method of claim 1 wherein the map being configured to enable a user to select a marker and automatically zooming the map in response to the user selection of the marker.

7. The method of claim 1 wherein the map being configured to enable a user to select a marker and automatically displaying a content item detail information block in response to user selection of the marker.

8. The method of claim 1 wherein the collection of pre-defined content item categories includes paintings, historical photographs, homages, portraits, seasonal works, and still lifes.

9. The method of claim 1 wherein the chronological arrangement includes an arrangement of content item information blocks configured in the timeline with a block of text providing detail information about dates or times related to a particular content item.

10. A system comprising:
a data processor,
a network interface, in data communication with the data processor, for communication on a data network; and
an artistic content management system, executable by the data processor, to:
retain one or more libraries of artistic or historical representations and related information as a plurality of content items in a database and make the libraries of content items available to networked computer users, wherein the content items are organized in the database in groupings related to one or more geographical locations, one or more categories, and one or more chronological arrangements, the one or more geographical locations including locations depicted by the content items, the one or more chronological arrangements including times indicative of when the content items were created;
provide a computer-implemented navigation facility to enable a user to select among a plurality of browse modes including a geographical browse mode, a categorical browse mode, and a temporal browse mode;
generate and present to the user, in response to user selection of the geographical browse mode, a corresponding map that includes markers identifying geographical locations related to the plurality of content items;
generate and present to the user, in response to user selection of the categorical browse mode, a corresponding collection of pre-defined content item categories related to the plurality of content items, and
generate and present to the user, in response to user selection of the temporal browse mode, a corresponding chronological arrangement that includes content item information blocks arranged in a timeline.

11. The system of claim 10 wherein the plurality of content items are obtained from a plurality of content sources via a data network.

12. The system of claim 10 being further configured to enable a user to select among a plurality of content item libraries.

13. The system of claim 10 wherein the one or more geographical locations including locations where the content items were created or locations where the creator of the content items resided.

14. The system of claim 10 wherein the map markers further including an indication of a number of content items associated with a particular geographical location.

15. The system of claim 10 wherein the map being configured to enable a user to select a marker and automatically zooming the map in response to the user selection of the marker.

16. The system of claim 10 wherein the map being configured to enable a user to select a marker and automatically displaying a content item detail information block in response to user selection of the marker.

17. The system of claim 10 wherein the collection of pre-defined content item categories includes paintings, historical photographs, homages, portraits, seasonal works, and still lifes.

18. The system of claim 10 wherein the chronological arrangement includes an arrangement of content item information blocks configured in the timeline with a block of text providing detail information about dates or times related to a particular content item.

19. A non-transitory machine-useable storage medium embodying instructions which, when executed by a machine, cause the machine to:
retain one or more libraries of artistic or historical representations and related information as a plurality of content items in a database and make the libraries of content items available to networked computer users, wherein the content items are organized in the database in groupings related to one or more geographical locations, one or more categories, and one or more chronological arrangements, the one or more geographical locations including locations depicted by the content items, the one or more chronological arrangements including times indicative of when the content items were created;
provide a computer-implemented navigation facility to enable a user to select among a plurality of browse modes including a geographical browse mode, a categorical browse mode, and a temporal browse mode;
generate and present to the user, in response to user selection of the geographical browse mode, a corresponding map that includes markers identifying geographical locations related to the plurality of content items;
generate and present to the user, in response to user selection of the categorical browse mode, a corresponding collection of pre-defined content item categories related to the plurality of content items; and
generate and present to the user, in response to user selection of the temporal browse mode, a corresponding chronological arrangement that includes content item information blocks arranged in a timeline.

20. The machine-useable storage medium of claim 19 wherein the plurality of content items are obtained from a plurality of content sources via a data network.
